(19) United States
(12) Patent Application Publication
(10) Pub. No.: US 2021/0014245 A1
(43) Pub. Date: Jan. 14, 2021

(54) IN-STREAM MALWARE PROTECTION

(71) Applicant: Trusted Knight Corporation, Annapolis, MD (US)

(72) Inventors: Theodore MCKENDALL, Lisle, IL (US); Trevor RESCHKE, Woodbury, MN (US); Jacob CARLSON, San Francisco, CA (US); Stanislav LIVSHITS, Haifa (IS)

(21) Appl. No.: 17/037,015

(22) Filed: Sep. 29, 2020

Related U.S. Application Data
(62) Division of application No. 16/206,692, filed on Nov. 30, 2018, now abandoned.
(60) Provisional application No. 62/593,361, filed on Dec. 1, 2017.

(51) Int. Cl. H04L 29/06; G06F 21/54

(52) U.S. Cl. CPC H04L 63/145; H04L 63/1466; H04L 63/02; G06F 2221/031; H04L 63/1483; G06F 2221/2125; G06F 21/54

(57) ABSTRACT

A protector server located in the Web traffic between an end-user computer and a Web site intercepts requests for Web pages from the Web site. The server inserts protection code into a Web page returned to the user computer which executes within the user browser. The code disables malware executing within the user browser by establishing itself as an event handler, finding likely malware in the stack, and disabling it. The code thwarts host-based malware by establishing itself as an event handler, and encrypting data fields of forms before the form is submitting to the operating system of the user computer. The code detects a Web inject attack by calculating a fingerprint for a form on the Web page and sending that fingerprint to the server. The server compares that fingerprint with one previously calculated for the form and generates an alert if different. The code detects a phishing attack by sending a notification to the server indicating within which domain it is executing. The server generates an alert if the received domain is different from an expected domain. The server provides a Web application firewall.

This application is a divisional of U.S. application Ser. No. 16/206,692 (attorney docket No. TKN1P005) filed Nov. 30, 2018, entitled “IN-STREAM MALWARE PROTECTION,” which claims priority of U.S. provisional patent application No. 62/593,361, filed Dec. 1, 2017, entitled “IN-STREAM MALWARE PROTECTION,” all of which applications are hereby incorporated by reference.

### FIELD OF THE INVENTION

The present invention relates generally to protecting against malicious software. More specifically, the present invention relates to disabling malware executing in a Web page, to thwarting host-based malware, to detecting Web inject attacks, and to detecting phishing attacks, all using protection code that is inserted into a requested Web page.

### BACKGROUND OF THE INVENTION

Risks to Web applications, to user host computers, to user private data (including user accounts and credentials), and to online transactions continue to increase due to proliferation of malware and due to its increased sophistication. Unfortunately, traditional approaches only address part of this problem and have had mixed results.

Threats include JavaScript-based keylogging malware (which typically executes in a Web page) and host-based keylogging malware (executing upon a user host computer), both of which are able to intercept private data from users using form grabbing and other techniques. Other types of endpoint malware are also threats. Stolen data can include user names, passwords and other sensitive information. A Web inject attack is able to display manipulated versions of Web sites via Web injection (adding a fake field, for example) and can also steal data and perform unauthorized transactions. A phishing attack redirects an unsuspecting user to a similar, but malicious Web site and also steals data. Attacks on the Web application itself may also occur in a Web site, such as Cross-Site Scripting (XSS) and SQL Injection (SQLi) attacks.

Attacks that target user browsers are one of the biggest threats, one reason being that JavaScript is used by nearly 95% of all Web sites, and JavaScript code does not need user interaction in order to execute. Attacks on the Web application itself are increasing. As modern Web sites are increasingly complex and user browsers are increasingly diverse, vulnerabilities can exist in many layers of the Web application. The Web application itself can be compromised, or malicious code can be introduced into a Web page via malicious advertisements, third-party libraries, other hacked Web sites, etc., that the Web application uses. A Web application that has become compromised is able to download malicious software to many of the host computers with which it communicates. A compromised Web page that is requested by the user can then execute within the user's browser in order to steal passwords and other data, distribute malicious software, redirect the user to phishing pages, etc. The upshot is that attacks on user browsers, user computers and Web applications are becoming more complex and harder to defend against.

Some examples from the past include: a JavaScript exploit that ran on a Web page in a customer browser forwarded credit card information from a customer to an external site; a Web application that hosted malicious JavaScript mined crypto-currency using customer browsers; a malicious browser extension in a Web store stole user names and passwords when a customer visited a specific banking Web site; and malware installed on the host operating system stole banking information and login credentials. Although numerous approaches have been tried to protect user computers and Web applications, each approach has not been optimal.

For example, computer security products focus on stopping theft, not fraud, and fraud tools focus on detecting fraud, not on security. Web application firewalls (WAFs) exclusively focus on protecting a Web application from direct attacks. This focus is important, but these WAFs are looking for known attacks like SQL injection, or enforce white list security to minimize zero-day and bespoke attacks. They do not try to understand whether the other end of the session (the user endpoint) is clean—and this is half of the transaction.

Endpoint protection for users can be effective within an enterprise (where the IT team has control of systems), but this protection can neglect a user viewing an enterprise Web site on his or her own (such as a customer connecting to a merchant Web site over the Internet from his or her home computer). Software can be provided to users to install on their endpoint computers, but it can be challenging to drive adoption and can cause user confusion. And, even if a user's computer is free from endpoint malware, the user computer can still be affected by Web-native malware such as that which runs in a Web page or a browser extension. Also, supporting different platforms (Microsoft, Apple, mobile, etc.) provide additional challenges. Fraud monitoring tools are typically focused on large datasets of user characteristics and transaction patterns in order to identify fraudulent transactions, flagging them for review or possibly blocking them but, there is no focus on security.

It is realized that there are a number of different users (and their computers) who may attempt to access a Web application over the Internet. First, there are the legitimate users who need reliable, secure access to the Web application. But, there are also attackers who attack the Web application directly, and there are attackers who try to disrupt service altogether (for example, a DDoS attack). There are also legitimate users on compromised devices, as well as criminals posing as legitimate users (using stolen credentials, false accounts, etc.). It is therefore realized that new techniques and systems are needed to counter this range of threats.

### SUMMARY OF THE INVENTION

Embodiments of the present invention: prevent the theft of sensitive information (from malware that tries to exfiltrate data or interfere with the user performing sensitive transactions); protect the Web application (from direct attacks and robot networks); and provide a system that is essentially frictionless, requiring no additional work for users, and minimal effort for customers to implement. More specifically, no additional software need be installed on the user endpoint computer nor on the computer server hosting the Web application, nor does the application itself need to be modified in any way. The invention provides protection during a Web session between the user and the enterprise that hosts the Web application and gives confidence to an application provider in a user's computer. Further, the same user computer may be tracked across different users once malware is detected. For instance, if endpoint malware is detected on a user computer when a user logs into a bank account, that same computer is flagged as being compromised for all future users. This flagging is done by fingerprinting the endpoint, and then flagging that fingerprint in the invention's server infrastructure. The creation of a device fingerprint for a user computer may be used in conjunction with, e.g., user names, IP addresses, etc., to track a device across different organizations.

Embodiments of the invention provide: malware protection (disabling JavaScript malware that tries to interfere with Web pages or tries to grab keystrokes or form data); data theft protection (field-level encryption of data being submitted blocks other host-based malware; Web page tampering detection (an alert occurs when malware modifies a Web page displayed to a user, e.g., to inject form fields or alter information); and detection of phishing attacks on the end-user. Another embodiment protects the Web application via an integrated WAF that protects against OWASP top vulnerabilities (SQL injection, XSS, etc.) and other attacks in order to stop direct attacks.

In a first specific embodiment, the invention inserts JavaScript software into a requested Web page before it is returned to a user host computer (the software being structured to run before any malware on the page is able to execute). Any malware, such as keylogging software that had been inserted into the page at the origin server or via a third-party library, is disabled or blocked by the inserted JavaScript software as it executes in the user's browser. Typically, a browser will execute JavaScript serially, starting from the top of the Web page. Preferably, the invention modifies the returned page and inserts the JavaScript software at the top of the page, before any other scripts, thus ensuring that the inserted JavaScript of the invention executes first. As some browsers may function differently, other techniques may be used to ensure the inserted JavaScript executes first in the user browser.

In a second specific embodiment, the invention protects against host-based malware also by inserting JavaScript software into a requested Web page before it is returned to a user host computer. When a user is filling out a Web form from a Web application, the invention encrypts all parameters for that Web form so that any malware can only send the encrypted parameters which cannot be decrypted by a malicious party. The invention decrypts the parameters before returning them to the origin server.

In a third specific embodiment, the invention protects against a type of Web inject attack used by malware executing on a host computer that typically modifies a Web page in the browser, e.g., it adds a fake field to a Web form. The invention inserts JavaScript software into a requested Web page before it is returned to a user host computer. The invention takes the original Web page from the origin server and calculates a fingerprint for that page. The same calculation is performed on the user's browser based upon the Web page modified by any malware. Both fingerprints are sent to a trusted computer server which compares the two fingerprints; different fingerprints mean that malware has changed the Web page and an alert is generated, the account is locked, the user is redirected to clean the host computer, etc. A fingerprint may be calculated for a single form of a Web page, a collection of forms, all forms, the entire Web page, for the DOM, or for any links or other elements of the page, i.e., for any data of the Web page. And, each form or element of the page may have its own fingerprint calculated. A fingerprint may be any suitable calculation of the data in question, such as by using a checksum.

In a fourth specific embodiment, the invention inserts protection code into a Web page requested by the user in order to detect a phishing attack. The code informs a trusted server on which domain the code is executing or provides contextual information, and, if the server detects that the code is now executing upon an unknown domain this indicates phishing and an alert is generated.

### BRIEF DESCRIPTION OF THE DRAWINGS

The invention, together with further advantages thereof, may best be understood by reference to the following description taken in conjunction with the accompanying drawings in which:

FIG. 1 illustrates a prior art system for accessing a Web application

FIG. 2 is a block diagram of a system illustrating the above discussed malware threats and a novel solution.

FIG. 3 illustrates in greater detail how the system operates.

FIG. 4 is a flow diagram describing injection of various protection mechanisms into a Web page.

FIG. 5 is a block diagram showing how the present invention may route a request through the protector server.

FIGS. 6A and 6B illustrate a first embodiment in which the invention disables keylogging malware executing in a browser of a user host computer.

FIG. 7 is a flow diagram describing how the protection code disables JavaScript-based key logging malware.

FIG. 8 illustrates an example of an event handler stack present within the browser on the user computer.

FIGS. 9A and 9B illustrate a second embodiment in which the invention thwarts keylogging malware executing on a user host computer.

FIG. 10 is a flow diagram describing how the protection code protects against host-based keylogging malware.

FIGS. 11A and 11B illustrate a third embodiment in which the invention detects a Web inject attack occurring on a user computer.

FIG. 12 is a flow diagram describing how the protection code detects a Web inject attack.

FIGS. 13A and 13B illustrate a fourth embodiment in which the invention detects a phishing attack against the user computer.

FIG. 14 is a flow diagram describing how the protection code detects a phishing attack.

FIGS. 15A and 15B illustrate a fifth embodiment in which the invention provides a Web application firewall (WAF).

FIGS. 16A and 16B are a flow diagram that describes one specific manner of implementing the embodiments of the invention in which the Cloudfront CDN is used to host protector server 100.

FIGS. 17A and 17B illustrate a computer system suitable for implementing embodiments of the present invention.

### DESCRIPTION

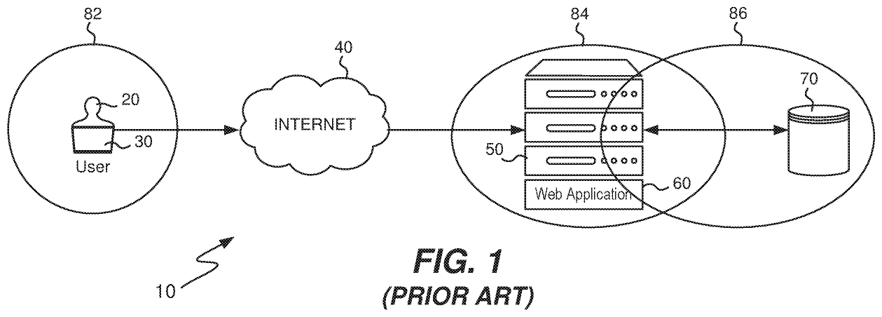

FIG. 1 illustrates a prior art system 10 for accessing a Web application. A user 20 utilizes a computer 30 in order to access a Web application 60 executing upon a server computer 50 over the Internet 40. The Web application can access a backend database 70. Endpoint anti-malware software exists, but unfortunately it only focuses upon its sphere of influence 82, i.e., it is installed by the user on the user computer. This endpoint anti-malware focuses on stopping attacks on the user computer, not on stopping fraud during a transaction or session with the Web application. Also, this endpoint anti-malware can be difficult to deploy outside of an enterprise and there can be software conflicts and platform limitations. This anti-malware does not know about the other side of the transaction (e.g., systems within spheres of influence 84 and 86), and it can be difficult to convince users to download and maintain this software on their computers.

Web application firewalls (WAFs) exist within sphere of influence 84, but are focused on security, not fraud. It can be challenging to scale this software and policy management can be complex. Like the endpoint software, WAF software existing solely within sphere 84 does not have the whole picture about what is happening within the entire transaction or session and only protects the Web application.

Similarly, fraud monitoring tools operating within their sphere of influence 86 only analyze transaction records in order to flag suspect transactions and are not aware of the entire session with the user, including activities occurring exclusively within spheres 82 or 84. These tools only focus on fraud detection, do not offer proactive security, and can be more complex, meaning that integration with other software may be needed.

It is now realized that existing anti-malware tools and techniques are missing the big picture, that is, they are unaware of the entire session occurring between the end-user host computer and the Web application. What is needed is full Web session security in order to protect end users, their endpoint computers, the Web application, and the enterprise that hosts the Web application during a session between the end user and the Web application. Accordingly, it is realized that a solution should protect not only the endpoint during a session (from those that try to exfiltrate data or interfere with transactions), but also should protect the Web application (from direct attack, robot networks, etc.).

Such a solution should also reduce fraud risk on both ends of the session, and should be essentially frictionless, meaning there is no effort required of the users and minimal effort required of the Web applications. Such a solution should not require the end user to download and install software nor require the Web application to install and maintain software.

### Invention Overview

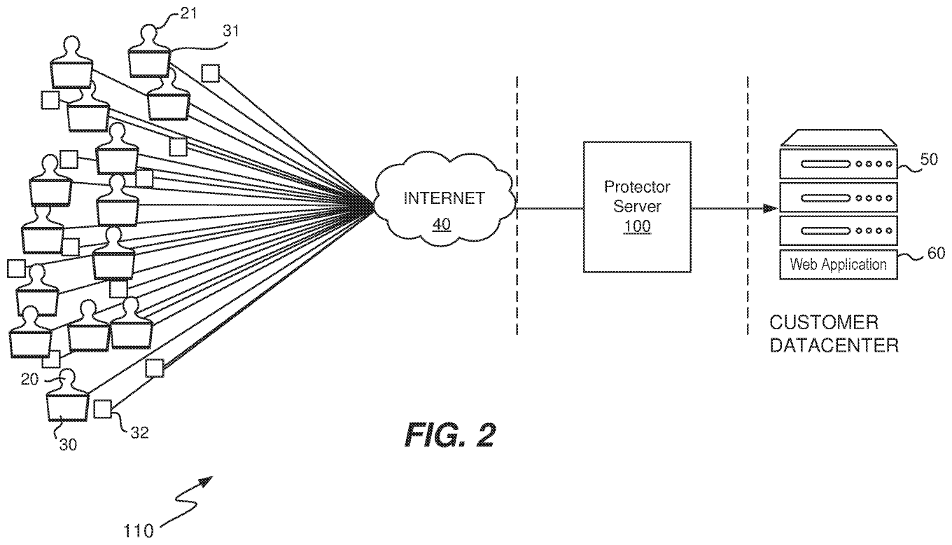

FIG. 2 is a block diagram of a system 110 illustrating the above discussed malware threats and a novel solution. Included are the legitimate users and their computers 20, 30 and 32 (referred to as “host” or “endpoint” computers), as well as server computer 50 and Web application 60 mentioned above. Of course, also shown are bad actors 21 and their computers 31 who attempt to compromise the Web application, install malware on the user's computers, etc., in order to commit fraud, steal sensitive information, etc. Server computer 50 is typically a computer in a customer data center of an enterprise such as a bank or retailer. Web application 60 is any suitable software application built by the enterprise using a Web framework (Ruby on Rails, React, etc.) or other software and accessed by user computers. Users 21 may also be accessing, in general, a Web site on computer 50 that hosts the Web application 60.

Additionally, a protector server 100 has been inserted between the end-user computers and the Web application. All Web traffic between a user's computer and the Web application now passes through server 100. Server 100 is an application written in any suitable programming language executing upon a server computer. Typically, server 100 will be computer code executing upon a server computer (e.g., on a dedicated machine, in a virtual machine, etc.) hosted by any cloud service provider (such as Amazon Web Services, AWS), but may also execute within any data center or within an enterprise that also controls server computer 50. Server 100 code is typically written in JavaScript, but may be written in other suitable languages such as C++, Rust, etc. Server 100 is arranged to insert protection computer code into a requested Web page that is requested by the end-user computer (or by a proxy server on behalf of the end-user computer) and then returned from the Web application back to the user's computer. Server 100 may be inserted in this path by modifying the DNS so that all Web traffic destined for the Web application flows through server 100.

Note that protector server 100 is typically installed at the request of, and by permission of, the enterprise that operates the customer data center and that operates server 50. Accordingly, the protection offered by server 100 exists while users are accessing server computer 50 in the context of a Web session with the enterprise. By virtue of the inserted protection code in the requested Web page that is returned to the end-user's computer, system 110 is able to provide protection for the user of computer 30, the user's data with regard to the enterprise, and the Web application during a session between the end user and the Web application. Further, system 110 protects the employees (and their computers) of any company by providing its services to any enterprise that may operate such a computer 50 or Web application 60, having a Web site visited by those employees. More specifically, system 110 prevents malware from stealing user data while the user computer is communicating with Web application 50. System 110 protects data that is entered by the user and protects data in any transactions (payments, money transfers, login activity, account updates, etc.) between the user computer and application 60. If the Web application is used by internal users of the enterprise they will also be protected.

The advantages of this approach are many. For one, one, it is simple to employ server 100's functionality by making a change to the DNS. This change is configured by the enterprise IT administrator and is known to those of skill in the art. In addition, there is no hardware or software to provision or scale for users or the enterprise, and there is no set up of policy management required of the Web application. Further, there is no integration or modification required of the Web application and no software installation or provisioning is required for the end user. And, the invention is compatible with a wide variety of operating systems and device types (e.g., desktop computers, mobile devices, tablets, etc.).

This technology can disable malware executing in a browser that interferes with Web pages and attempts to steal user credentials and other form data, it thwarts host-based malware from stealing data, it detects malware that is modifying Web pages and Web forms in order to steal data, and it detects phishing attacks by detecting when a Web page is executing in an unknown domain. In addition, system 110 provides a Web application firewall to protect the Web application by defending against direct application attacks on all layers (Web server, operating system, business logic, etc.). And, the scalability of this technology in the cloud also mitigates disruption from distributed denial of service (DDoS) attacks.

### Injection of Protection Mechanisms

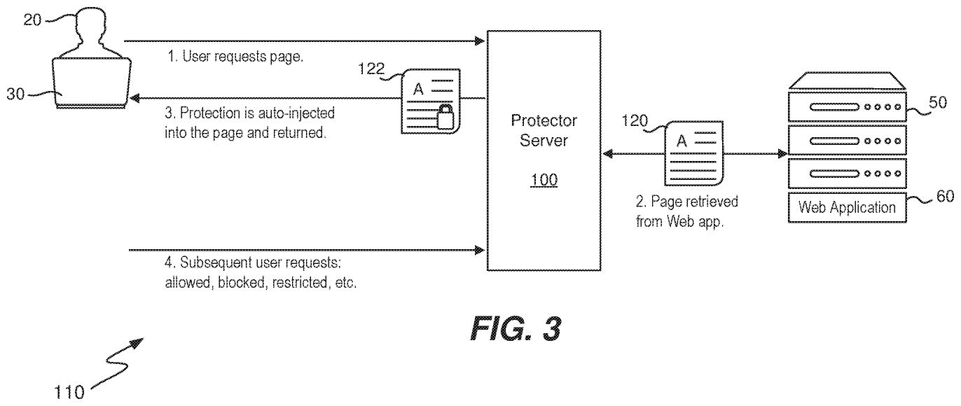

FIG. 3 illustrates in greater detail how system 110 operates. Shown again are a user with a computer, a server computer 50, Web application 60, and server 100 inserted between the user and Web application. Server 100 has been inserted by modifying an entry of the DNS, for example. In the first step, in the course of interacting with a Web application during a user session, the browser of the user computer requests a Web page from the Web application. This request is routed through server 100 so that when the Web page 120 is retrieved in the second step it is returned to server 100. In the third step, the server 100 automatically inserts protection code into the Web page before it is returned to the user browser. The protection code will then execute within the user browser and is then able to protect the user computer and Web application from malware threats during that session, and is able to allow, block or restrict subsequent user requests. Again, no extra software need be installed on the end-user computer nor on server computer 50, nor does the Web application need to be modified. The protection code provides malware protection, data theft protection, Web page tampering protection, anti-phishing protection, as well as correlation across enterprises of compromised endpoints.

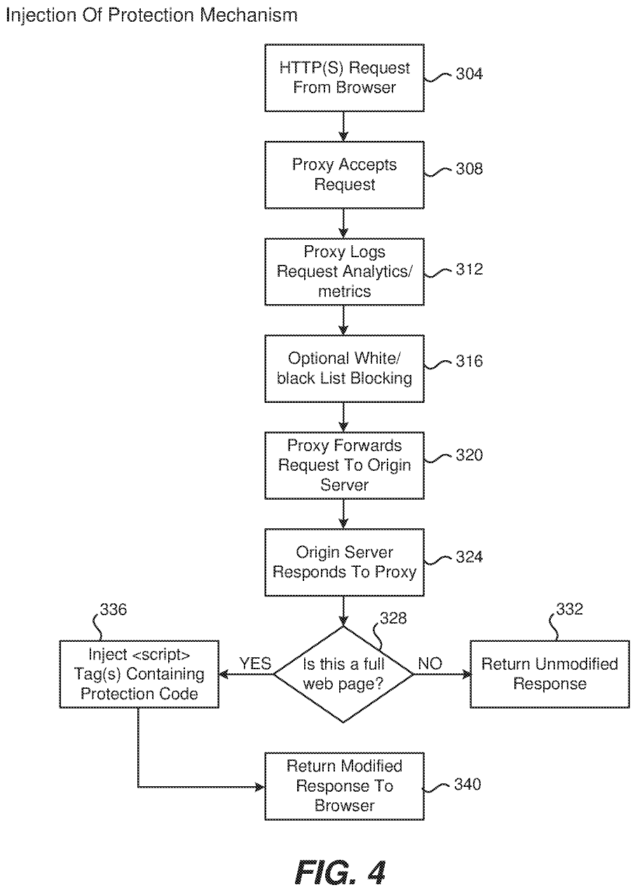

FIG. 4 is a flow diagram describing injection of various protection mechanisms into a Web page. In this scenario, user 20 desires to engage in a Web session with Web application 60 perhaps to conduct a transaction, to gather information, to provide information to the Web application, to log in to the Web application using his or her user credentials, etc. The user may be contacting the Web application in order to formally log in, or may simply be connecting to the Web site of the enterprise in order to gather information, etc. The system can be configured to inject a protection mechanism into the response to every Web request, or only into responses to specific Web pages. In one embodiment, there are configuration files on protector server 100 that list specific URLs to inject into or specific URLs not to inject into. Preferably, the default is to inject the protection mechanism into all returned Web pages. In addition, there are also configuration settings of protector server 100 that can be set per-enterprise, per-Web site, or per-Web page in order to control which protection mechanisms are inserted into which returned Web pages. Thus, server 100 may control which of the various protection mechanisms described in detail below (JavaScript-based malware, host-based malware, Web-inject attack, anti-phishing, etc.) are inserted into which returned Web pages.

From the standpoint of server 100, a session begins once a user first contacts a Web site (and not necessarily after a user has logged to a Web application) or after a specified, configurable, session timeout. The session then continues while the user is interacting with the Web application, and ends after the timeout period.

In order to take advantage of the protection offered by protector server 100, and to insert that server in the Web traffic between user 20 and computer server 50, the enterprise that operates the Web site of which Web application 60 is a part, modifies, agrees to have modified, or requests to modify, the DNS entry corresponding to the enterprise or to its Web site. Using “www.example.com” as an example link to the Web application, the enterprise (or third party) creates a DNS CNAME (canonical name) for the origin Web application's host name to point to the host name of protector server 100. In this way, all traffic destined for “www.example.com” is diverted to protector server 100, which will then forward any request to the origin Web application. Alternatively, the enterprise may set an A record for “www.example.com” to point to protector server 100. Accordingly, any user request destined for the Web site will now be routed through protector server 100.

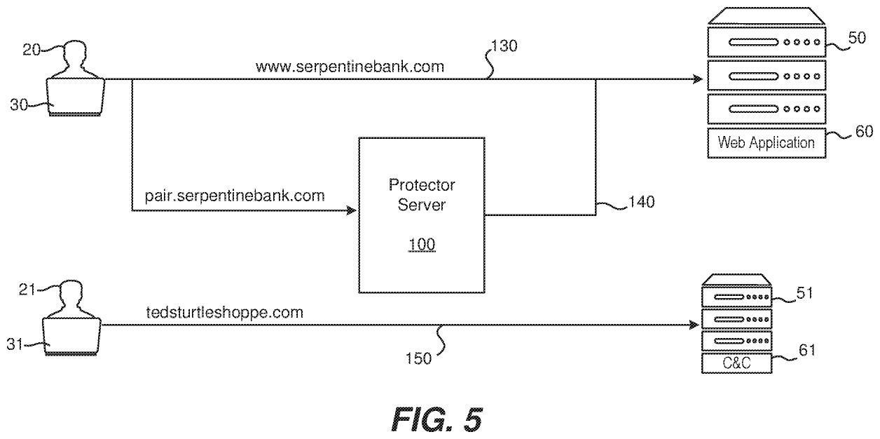

FIG. 5 is a block diagram showing one embodiment of how the present invention may route a request through the protector server 100. Shown again is a user 20 on a computer 30 connecting via link 130 to a server computer 50 that hosts a Web application 60 or a Web site. A malicious user 21 operates a computer 31 which communicates over the Internet over link 150 to a server computer 51 that executes malicious command and control (C&C) software 61. While communicating via link 130 (a direct link to the Web site) the user and the Web application is not afforded any extra malware protection and may be at risk of being compromised or losing sensitive information to malicious user 21.

But, when the user browser connects via a link 140 through server 100 the benefits of the present invention are realized. Using “www.serpintinebank.com” as an example of a Web site that has been compromised, the DNS has been modified so that user connects to the Web application via “pair.SerpentineBank.com” instead of via “SerpentineBank.com.” Accordingly, the user and the Web application will be afforded protection from malicious user 21 and C&C software 61. In the subsequent figures, this example will be expanded upon to demonstrate protection against JavaScript-based keylogging malware, host-based keylogging malware, a Web inject attack, and phishing attacks, as well as a technique for correlation across enterprises of compromised endpoints.

In another embodiment, all Web traffic to “www.serpentinebank.com” from user computers is routed through protector server 100 because of the change to the DNS, as mentioned above, and the user and Web application will be afforded protection.

At some point during the session, in step 304 the user's browser will issue an HTTP request for a resource on the Web site of origin server 50. This will typically be a URL request for a resource such as a Web page, image, movie, stream, etc. In a current embodiment, a request for a Web page will be modified as described below, while a request for an image, movie or stream will return that requested resource unchanged to the user. Next, in step 308 server 100 (also referred to as the proxy server) accepts this request from the user instead of having the request go directly to a server computer 50 by virtue of the DNS change.

In an optional step 312 the proxy server may log any metrics and data for future reporting or analytics such as geographic location of the user, IP address, account information (e.g., user name), reason for logging, timestamp, URL, arguments accompanying the request, browser and endpoint type, and other metadata and contextual information about the request.

In another optional step 316 the proxy server may also provide white listing or blacklisting on behalf of the Web application. For example, the proxy may provide a white list of only those URLs to which a user is allowed access within the Web application (e.g., a login page) and a blacklist of those URLs to which a user is not allowed access (e.g., an administrator page). Both whitelists and blacklists may be created either manually or via automation.

Next, in step 320 the proxy server forwards this request to the origin server 50. In step 324 the origin server responds to the proxy server by returning the requested Web page or other resource. In step 328 the proxy server determines whether or not this is a full Web page as opposed to any component of a Web page (such as an image, movie, stream, etc.). If not a full Web page, then in step 332 the response from the origin server is returned unmodified to the user computer 30. If yes, then in step 336 the proxy server inserts the protection code into the requested Web page.

Depending upon the language in which the Web page is written, this insertion may be done in different manners. In one preferred embodiment, the Web page is in HTML and step 336 is performed by first writing a new script tag into the top of the Head section of the Web page. Then, the protection code (JavaScript code, in this example) is added within the script tag. The protection code may also be written directly into the returned Web page, or a reference to the code's location may be written into that Web page via the ‘src’ attribute of the script tag. In the latter case the endpoint's browser will fetch the protection code from the specified location and begin executing the retrieved code immediately before any potential malware in the page executes. This code may be stored on any system accessible by the browser of the endpoint computer. Next, in step 340 the modified Web page is returned to the user browser.

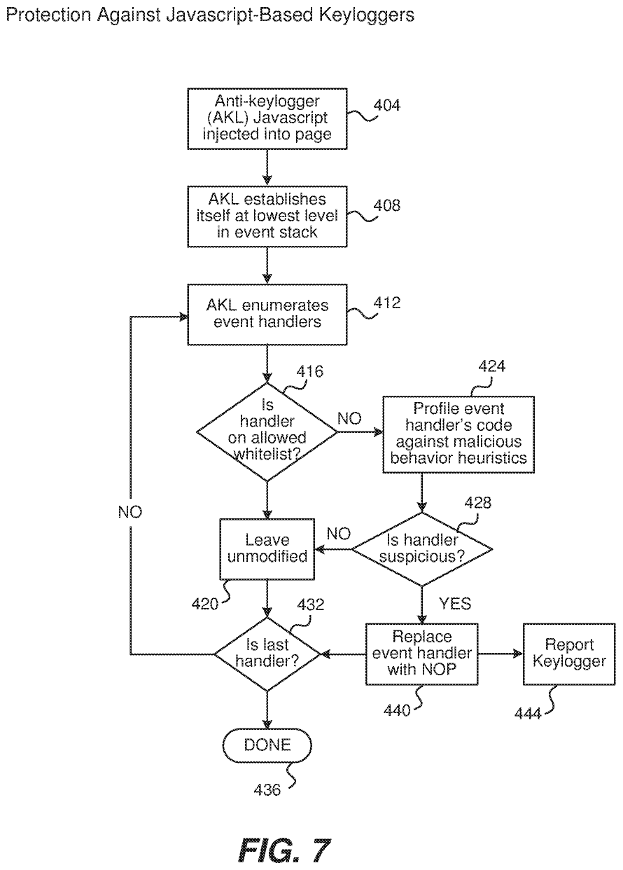

The protection code inserted may perform any of a variety of functionalities. As will be explained in greater detail below in FIGS. 7, 10, 12 and 14, the protection code provides protection against JavaScript-based key logging malware, host-based key logging malware, Web-inject attacks or phishing attacks. Depending upon which type of protection is desired by the enterprise for the Web application, any or all of this protection code may be inserted. In one preferred embodiment, all types of protection code is inserted.

It should be pointed out that even though the above describes how a user makes an HTTP request of a Web application and how JavaScript protection code is inserted into an HTML page, the invention is not so limited. By way of example, the Web page may use other languages such as XML, ASP, JSP, PHP, or any other text-based document type served by an application server. And, the user may be requesting a resource from an application over a network that is not necessarily a Web application (i.e., not an HTML request). An example may include a JSON or JSONP response.

Once the modified Web page is returned to the user browser the inserted JavaScript code begins executing within the user browser in order to provide the protection offered. The protector code is injected before (i.e., above) any other code, ensuring that when the browser begins executing the page's code the protector code will always execute first.

### Protection Against JavaScript-Based Key Loggers

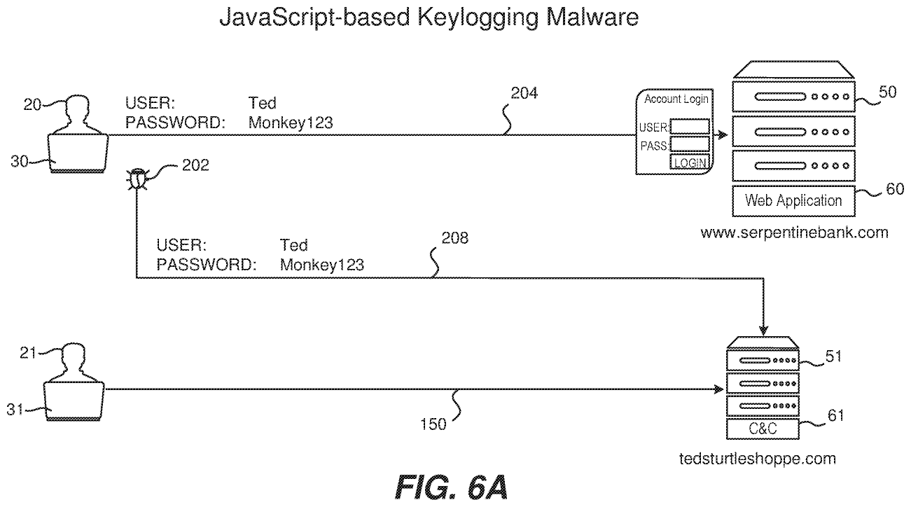

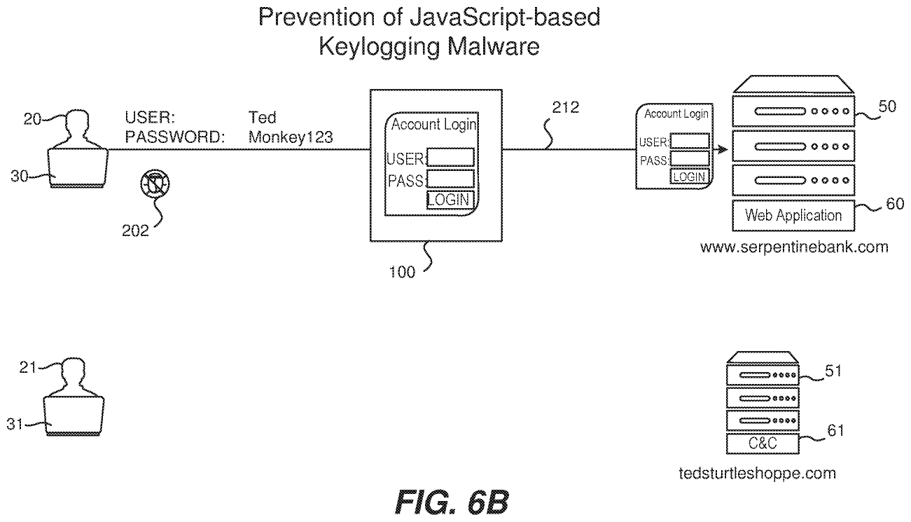

FIGS. 6A and 6B illustrate a first embodiment in which the invention disables keylogging malware executing in a browser of a user host computer. FIG. 6A illustrates how a malicious user 21 may steal sensitive information from a user via malicious software 202 before use of the present invention. As explained above, malware 202 may have been downloaded inadvertently via a Web page by user computer 30 and is now executing within the computer browser. Typically, this is a JavaScript-based keylogger, although other types of malware may also exist (such as malware that may try to manipulate data, or use other exploits such as drive-by-downloads or cryptojacking), and this embodiment is also able to disable that malware. The malware may either be part of the page served by the origin site, or it may be part of a third-party library loaded by the page.

When the user interacts with Web application 60 over Internet link 204 in order to submit account login information, malware 202 captures this information and sends it surreptitiously over link 208 to the C&C software 61 on the malicious user's server computer. The malicious user now has the user's user name and password, for example.

FIG. 6B illustrates how this embodiment of the invention prevents such malware from executing and stealing information. As explained earlier, protector server 100 is now present in the Web traffic path between computer 30 and server computer 50 and has inserted protection code into a Web page that was earlier downloaded to the user computer. As will be explained in greater detail below, this protection code executes within the browser of the user computer and prevents JavaScript-based malware 212 from executing, thus preventing any transfer of information from computer 30 to the malicious C&C server 51. The account login information is thus transferred safely over link 212 via the protector server 100.

FIG. 7 is a flow diagram describing how the protection code disables JavaScript-based key logging malware. In step 404 the protection code (i.e. the anti-keylogger, also known as an AKL) is inserted into a downloaded Web page as has been described above in FIG. 4. Once present on the user computer in the Web page, in step 408 the AKL code executes and installs itself as an event handler and establishes itself at the lowest level in the event handler stack. The AKL code is executed as soon as the browser begins executing the page's JavaScript, before any other code can execute, as described above.

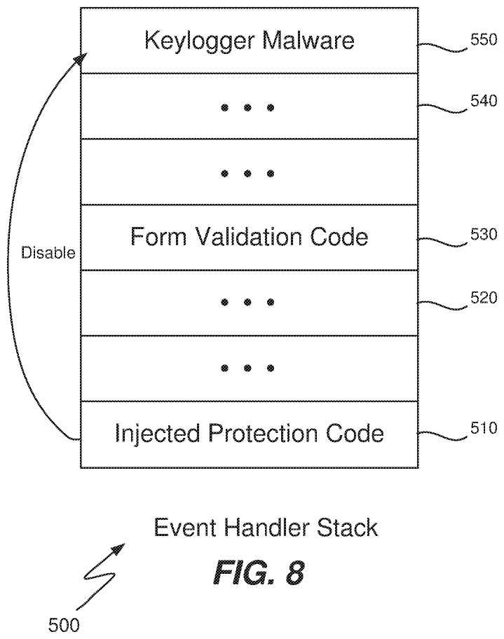

FIG. 8 illustrates an example of an event handler stack 500 present within the browser on the user computer. The event handler stack 500 represents the Web page event stack.

As known in the art, such a stack of routines is used by a Web page in a browser in order to respond to an event that occurs on the user computer and browser, such as a key press, form submission, or mouse page load. When an event occurs, the browser “bubbles up” this event through this chain of event handlers from the bottom to the top, executing the lowest level event handler (if appropriate) first. As shown in FIG. 8, the AKL code 510 has established itself at the lowest level in the event handler stack such that it will be called first when an event occurs. It may also be called at page load time. Such a technique allows the protection code to execute before any malicious event handler code has a chance to execute. Also shown in the event handler stack is a legitimate event handler, form validation code 530, which performs form validation of the Web application, and an illegitimate event handler, keylogger malware 550, which will attempt to steal information or perform other malicious activity. Preferably, the protection code 510 maintains its position not only vis-a-vis the malware (i.e., below malware 550), but at a lower level than all other event handlers in order to ensure that additional malware handlers are not given a more privileged access level. Thus, it is preferable that code 510 is at the bottom of the stack. As is known in the art, each element in the stack contains a function pointer that is registered as an event handler, rather than the entirety of the code itself. Thus, a function pointer identifies where the actual code is located in the Web page.

As shown at 520 and 540, other event handlers (legitimate or illegitimate) may also be present within the event handler stack. And, it is not necessary that the keylogger event handler be present within the event handler stack. The invention will continue to operate and provide protection for the user computer even if the keylogger malware is not present on the user computer, or even if the keylogger malware is not detected by the present invention or by other software. The keylogger event handler 550 is shown at the top of the event handler stack, but it may occur in other locations within the stack.

In step 412 the AKL code executes and enumerates all of the other event handlers within the stack 500. Typically, this will occur when a first event is detected within the browser, but may also occur at regular intervals later in the lifetime of the Web page in order to detect the addition of any new event handlers.

In other words, the AKL code identifies every other event handler within the stack and attempts to determine whether or not each event handler is allowed, is suspicious, or is identified as being malicious. The AKL code may determine a signature of each event handler (such as a hash value, etc.) or may use heuristics to determine whether not the event handler is malicious. Accordingly, in step 416 (an optional step) the AKL code determines whether or not a particular handler is on an allowed white list (using such a signature); if so, then control moves to step 420, but if not, control moves to step 424. If step 416 is not used, then control moves directly to step 424 from step 412. Typically, the AKL code will use the function pointer in the stack to identify the location of the actual event handler code in order to analyze the code.

In step 424 the AKL code profiles each event handler's code against a variety of behavior heuristics known to malicious code, and known to keyloggers in particular. We can use multiple, layered techniques to determine if code is malicious. By way of example, the AKL code determines whether or not the event handler fetches an image, font, style sheet, etc., from a different domain, or whether the event handler fetches resources from a domain different from the Web application (behaviors known to keyloggers). Specifically, we can detect if code changes the location of an <img> tag, which is a common way to avoid the cross-domain policy of a browser in order to exfiltrate stolen data. Or, the code might store data from a form in an unusual way. The AKL code may also use other heuristics to identify other types of malware other than keylogging malware.

In step 428 if the event handler is not deemed suspicious then in step 420 the event handler is left unmodified and no other action need be taken with respect to that event handler, and control moves to step 432. Additionally, a whitelist of known-benign handlers may be created to specifically allow certain actions. But, if the event handler is deemed suspicious, or is determined to be malicious, then in step 440 that particular event handler is disabled. Note that it is not necessary for the AKL code to detect the presence of actual malware on the user computer, nor is it necessary for the AKL code to make any determination that malware is present. If the AKL code determines that a particular event handler is suspicious then it may take steps to disable that event handler. The event handler (i.e., any potential malware) may be disabled in many different ways such as by removing the event handler from the event handler stack, replacing the function pointer with a pointer to benign or non-existent code, changing the event handler code itself to make it benign (such as by removing the event handler code, modifying the code, replacing the code with a “NOP,” etc.) or by disabling the event handler in other manners such as by replacing the event handler's prototype, etc.

Once disabled, in step 444 the AKL code reports the suspicious event handler by sending a message to the protector server 100, although this step is optional as well. Other actions may be taken by the AKL code or by protector server 100 such as blocking the user's session at the protector server to prevent access to the Web application.

Next, control returns to step 432. Step 432 determines whether other event handlers remain in the stack that have been enumerated, and if so, control returns to step 412 in order to iterate over all of the event handlers. If all event handlers have been analyzed by the AKL code, then the AKL code terminates in step 436.

### Protection Against Host-Based Key Loggers

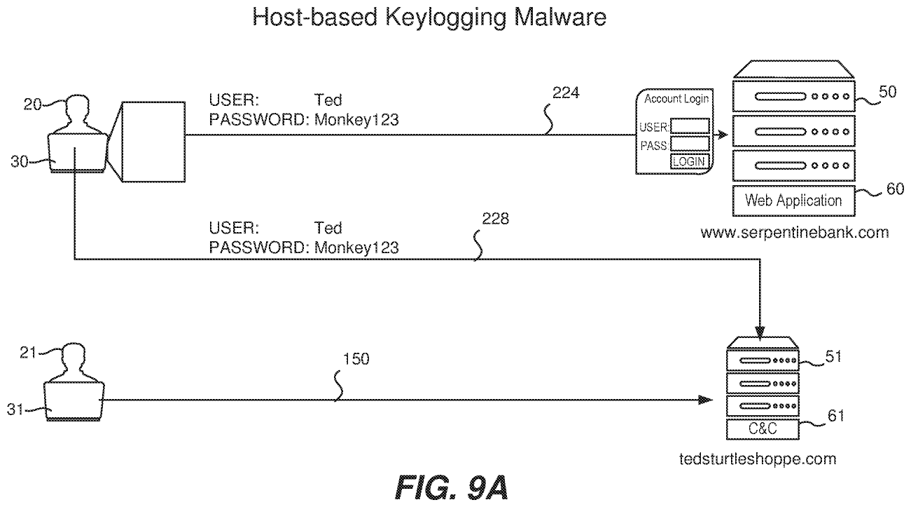

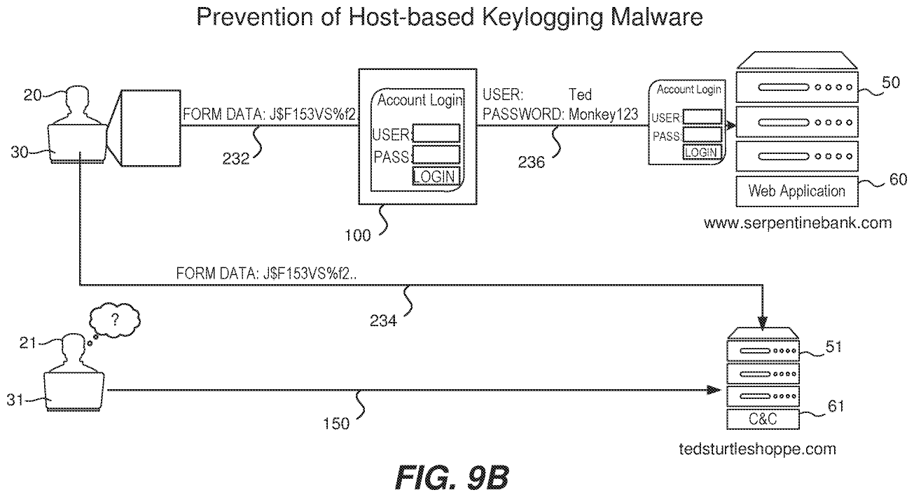

FIGS. 9A and 9B illustrate a second embodiment in which the invention thwarts keylogging malware executing on a user host computer. FIG. 9A illustrates how a malicious user 21 may steal sensitive information from a user via malicious software before use of the present invention. As explained above, this malicious software may have been installed upon the user computer using any of a variety of techniques, and is executing within the operating system of the computer. When the user interacts with Web application 60 over Internet link 224 in order to submit account login information, the malware captures this information and sends it surreptitiously over link 228 to the C&C software 61 on the malicious user's server computer. The malicious user now has the user's user name and password, for example. Because this malicious software is executing on the user computer and not within the user's browser, this embodiment uses a different technique.

FIG. 9B illustrates how this embodiment of the invention thwarts such malware from stealing information. As explained earlier, protector server 100 is now present in the Web traffic path between computer 30 and server computer 50 and has inserted protection code into a Web page that was earlier downloaded to the user computer. As will be explained in greater detail below, this protection code executes within the browser of the user computer and encrypts any data 232 that might be stolen; the protector server then decrypts this data 236 before returning it to the Web application 60. But, the form data 234 grabbed by the malware is encrypted before being sent by the malware to its C&C server 51, thus thwarting the malicious user from obtaining relevant information. The malicious user 21 will not be able to decrypt this data because it does not have the encryption key, nor knowledge of how it was encrypted.

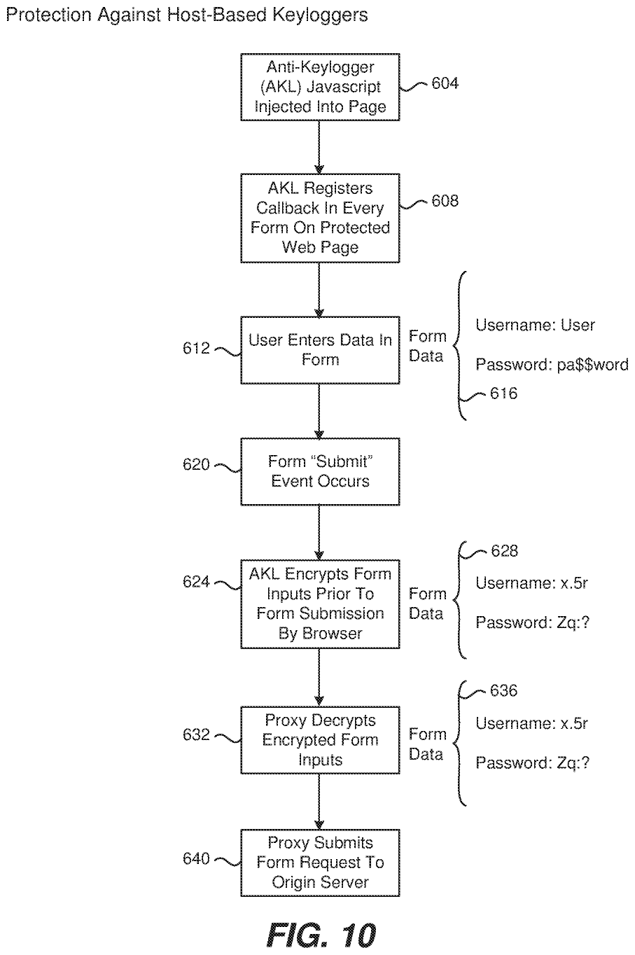

FIG. 10 is a flow diagram describing how the protection code protects against host-based keylogging malware. In step 604 the protection code (e.g., anti host-based-keylogger, AHKL, code) is inserted into a downloaded Web page as has been described above in FIG. 4. Once present on the user computer, in step 608 the AHKL code installs itself as an event handler and establishes itself at the lowest level in the event handler stack for at least one form on the downloaded Web page. For example, FIG. 8 shows an event handler stack which may be for a particular Web page in which the AHKL code is established at the lowest level. The AHKL code can register as a callback for every form on the downloaded Web page so that it can execute upon any form submission event on that page in order to encrypt form data as will be explained below. It is not required, though, that the AHKL code register for every form on a page.

Next, in step 612 the user enters data 616 into a particular form on the page (such as the “Account Login” form of FIG. 9B). Even though this data entry is an event, the AHKL code will take no action upon this event. Once the user has finished entering the data, the user submits the form in step 620 and a form “submit” event occurs, triggering execution of the AHKL code. An application of the computer (such as a password manager, the browser itself, etc.) may also enter data 616 (e.g., a saved password, e-mail address or other) into a particular form.

The AHKL code then proceeds in step 624 to encrypt the data entered into the form by the user, resulting in, for example, encrypted data 628. Any type of encryption or obfuscation may be used, although it is preferable that the encryption or obfuscation is reversible by the protector server 100 and not by any other party, such as by the C&C software 61 under control of the malicious user 21. By way of example, the AHKL code may use symmetric encryption with the encryption key also being known by the protector server 100. Preferably, asymmetric encryption (e.g., PKI encryption) is used, where the AHKL code encrypts the data using the public key, and the corresponding private key is stored only on the protector server 100. Further, although it is preferable to encrypt all forms of a particular Web page using the same encryption key or encryption technique, it is possible to encrypt each form on a Web page with a different key for each form or even using a different encryption technique for each form. In this scenario, each form is tagged with a particular identifier identifying the encryption technique and key that was used, so that the server protector 100 will be able to decrypt each form.

How the data is encrypted may be performed in different manners. Although it is preferable to encrypt all of the data in a given form (e.g., both the user name and password in a login form), it is possible to encrypt only certain fields of that form, for example, only the password. Also, while it is possible to only encrypt the actual data from particular fields (e.g., only the user name and password), in one embodiment the entire submission string for that form (e.g., all parameter data following an “&”) is encrypted and that encrypted submission string is then given a new parameter name which can be identified by the server protector 100 as including encrypted form input data.

Preferably, encryption occurs prior to the browser constructing the form submission request and before the form submission request is submitted to the operating system of the user computer for eventual delivery to the Web application 60. Thus, the encryption occurs before any malware executing in the browser's address space can access the form data.

In this embodiment, because it is believed that host-based malware (such as a keylogger or form grabber) might be present on the user computer, any form data input by the user is susceptible to being stolen by malware. When the encrypted form data 232 is sent to server protector 100, it is possible that malware executing on the user computer will also send this encrypted form data 234 (received from the user's browser after encryption by the AHKL code) to server computer 51 under control of the malicious user 21. But, because the data is encrypted, and because the malicious user does not know the encryption technique used nor the encryption key, he or she will not be able to understand or use the stolen encrypted data.

In step 632 protector server 100 receives the encrypted form data and is it is able to decrypt this data using the known encryption technique and the encryption key in its possession. If all forms on a Web page are encrypted using the same technique and key, then the protector server knows which technique and key to use for decryption. If different forms use different encryption keys, then the protector server references the identifier returned with each form in order to determine which key to use for decryption. Once decrypted, in step 640 the form request and data (e.g., data 636) is returned over link 236 to the Web application.

In an alternative embodiment, typically the entire transmission is encrypted with TLS (HTTPS) as is normal with Web applications, so that any data is not sent in the clear. In this alternative, use of the invention above (form-field encryption) results in essentially double-encryption (in order to safeguard the data from malware on the user's computer), which occurs before the data enters the secure transmission link.

As with the protection against malware described in FIG. 7, there is no need in this second embodiment to determine if malware exists upon the user computer or within the user's browser. In one variation of this embodiment, protector server 100 keeps a log of which forms in a particular Web page returned to the user computer should include encrypted data. When the form is returned to the protector server, if a form or forms is returned without encrypted data, this indicates that malware may be executing upon the user computer and an appropriate notification, alert, etc. may be generated by protector server 100. Optionally, the endpoint may then be blocked from accessing certain (or all) Web pages on subsequent requests. While data from all forms on a page may be encrypted, in one particular variation, only “post” requests are encrypted and not “get” requests for efficiency.

### Protection Against Web Inject Attacks

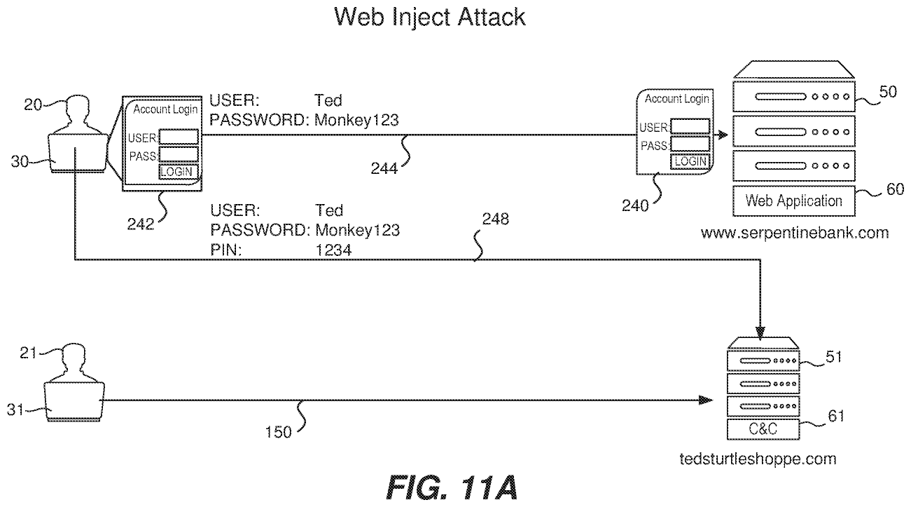

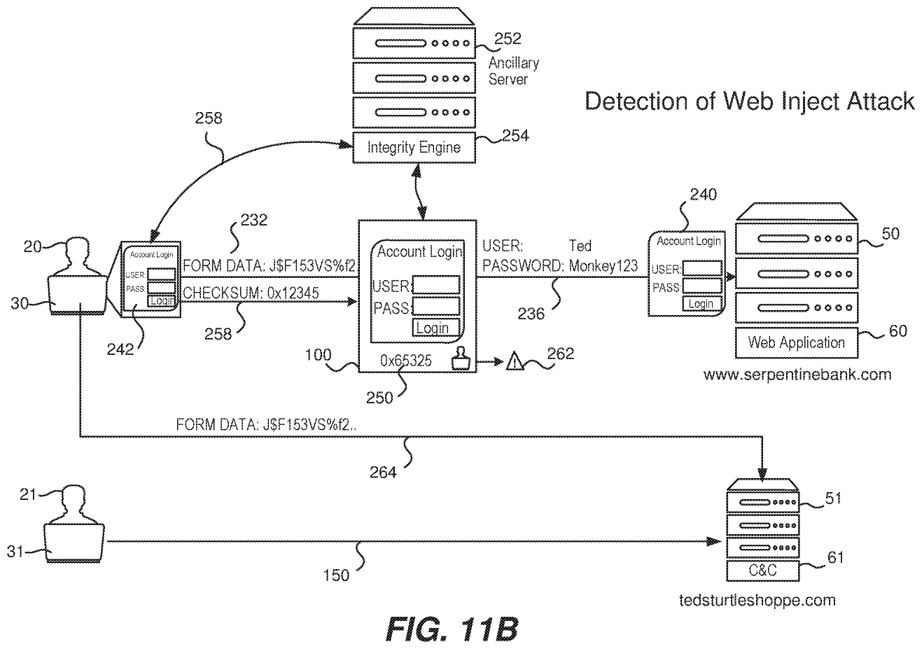

FIGS. 11A and 11B illustrate a third embodiment in which the invention detects a Web inject attack occurring on a user computer. FIG. 11A illustrates how a malicious user 21 may steal sensitive information from a user via malicious software before use of the present invention. As explained above, this malicious software may have been installed upon the user computer using any of a variety of techniques, and is executing within the operating system of the computer.

When the user interacts with Web application 60 over Internet link 244 in order to submit account login information (for example), the Web application includes a form 240 that is downloaded as part of a Web page over link 244 to the user computer 30. The malware executing upon the user computer, however, modifies form 240 in order to produce a fake or modified form 242 that appears on the Web page in the user's browser—instead of the original form 240 returned by the origin server. The fake form 242 appears to also require that the user type in their personal identification number (PIN). Once the user does this, the malware captures this information and sends it surreptitiously over link 248 to the C&C software 61 on the malicious user's server computer. The malicious user now has the user's PIN, for example. This malware is thus able to ask for and steal sensitive data that was not part of the original form on the Web page. Because this malicious software is executing on the user computer and not within the user's browser, and because a Web inject attack is different than a keylogger (for example), this embodiment uses a different technique than those previously described.

FIG. 11B illustrates how this embodiment of the invention detects that such malware is operating on the user computer. As explained earlier, protector server 100 is now present in the Web traffic path between computer 30 and server computer 50 and has inserted protection code into a Web page that was earlier downloaded to the user computer. When the Web page is first received at protector server 100, this server sends the Web page to an integrity engine server software 254 executing upon an ancillary server computer 252. Server 254 is server software executing upon a physical machine which may be the same machine upon which protector server 100 is executing, may be a different machine, may be executing within the same or different virtual machine, or may be the within server 100. The integrity engine server renders the Web page in the same way the user's Web browser would render it and calculates a fingerprint or checksum for the Web page or of each form in the page. Alternatively, server 100 calculates the checksum or sums and sends these to engine server 254.

On user computer 30, the protection code also calculates a fingerprint or checksum for the Web page or of each form displayed on the user computer (which may have been modified by Web inject malware executing upon the user computer). The protection code then sends this client-side checksum 258 to integrity engine 254. This data may be sent directly to the integrity engine server or indirectly via the protector server. The integrity engine compares the two checksums, and, if different, generates an alert. FIG. 11B also shows an alternative embodiment in which protector server 100 calculates and stores fingerprints (such as checksum 250 of form 240), and in which the protection code of the user browser sends its calculated checksum 258 of form 242 back to protector server 100 for comparison. In this alternative embodiment, the checksums do not match and an alert 262 is generated.

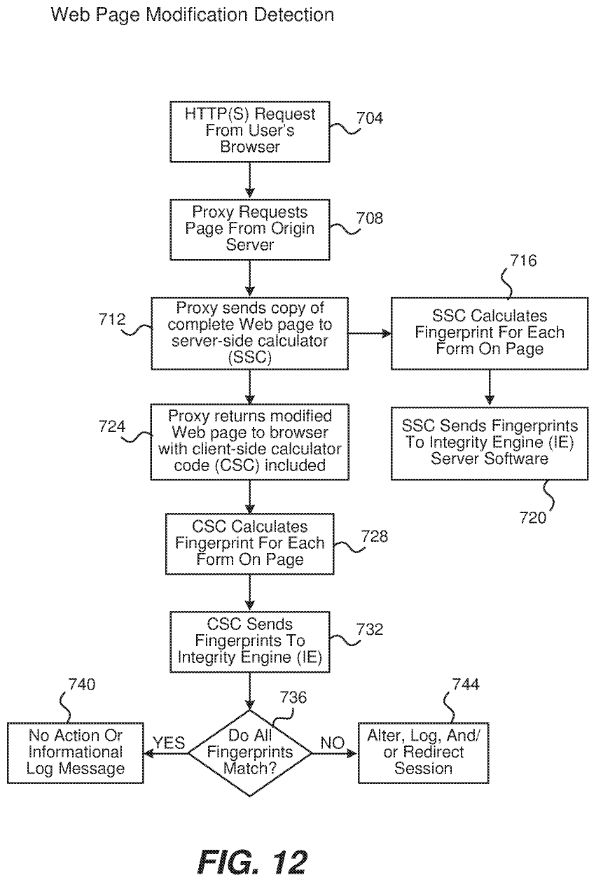

FIG. 12 is a flow diagram describing how the protection code detects a Web inject attack. In step 704 an HTTP request is sent from the user's browser to Web application 60 and is redirected to protector server 100 as has been described above. Next, in step 708 protector server 100 requests the desired Web page from origin server 50. When the page is returned to the user computer, protector server 100 inserts protection code as has been explained above in FIG. 4. This protection code will then execute in the browser of the user computer as explained below.

In step 712 protector server 100 sends a copy of the complete requested Web page to server-side calculator (SSC) code within integrity engine 254. This SSC code may be present within the integrity engine 254 or may be present within other server software. In step 716 the SSC code calculates a fingerprint for each form on the received Web page. Alternatively, the SSC code need not calculate a fingerprint for each form, but calculates a fingerprint for at least one of the forms.

A fingerprint is a data value, image, or other identifying characteristic of a form. By way of example, a fingerprint may be as simple as a number indicating the number of input fields of the form, may be a checksum of the form, may be a hash value of the HTML code of the form or other signature, or may be as complex as a restructuring of the DOM object of the form, etc. Preferably, a fingerprint is calculated in the same way for each form of the page, although fingerprints may be calculated differently for different forms on a page. A fingerprint preferably identifies <form> elements (and their child elements) on a Web page. Since the exact same calculation is performed in the SSC as is performed on the CSC (for a given form), the fingerprint calculated by the CSC for a form should match the fingerprint calculated by the SSC for that same form, unless the form (or its child elements) has been modified within the browser, presumably by malware (e.g., a Web Inject attack). A fingerprint is saved in a database in association with the integrity engine along with an identifier of the Web page and an identifier of the particular form. If the SSC code is not present within the integrity engine, then in step 720 the SSC code sends these fingerprints and identifiers to integrity engine 254. Alternatively, the SSC may cache the fingerprints so that it does not always have to perform the calculation for every form every time a Web page is sent.

Returning now to step 724, protector server 100 returns the requested Web page which includes the inserted protection code. This code also includes client-side calculator (CSC) code for calculating fingerprints of forms on the Web page on the client computer. At this point in time, it is possible that malware executing upon user computer 30 will modify any form or forms of the received Web page in order to steal sensitive information. Assuming that such malware is successful, it may create and display form 242 on the browser of the user computer (as well as other modified forms). Typically, malware will modify a form by the time the form is displayed to the user.

In step 728 the CSC code executing within the user's browser will calculate a fingerprint for each form displayed on the Web page. Fingerprint calculations may occur using any of the techniques described above, with the understanding that fingerprint calculations performed by the CSC code for a particular form are performed in the same way as were performed by the SSC code in step 716 above (i.e., if a hash was used on form 240, the same hash will be used upon form 242). This calculation may occur after the form is displayed to the user, when a page loads, at form submission time, after the document has been rendered on screen, or when the form is submitted. Preferably, the protection code installs itself as an event handler which is triggered by any one of these events so that the calculation happens after any forms have been modified by the malware. Because we know when the form has been rendered by the browser, the calculation will happen after the malware has modified a form. As above, it is desirable that the protection code is installed in the stack such that it is called first (before any malware which may try to disable the protection code).

Next, in step 732 the CSC code sends all fingerprints to integrity engine 254 as shown by link 258. In step 736 the integrity engine 254 now compares all fingerprint pairs that have been calculated by the SSC code and the CSC code in order to determine if all of the calculated pairs match. For example, the fingerprint of form 240 will be compared to the fingerprint of form 242, etc. If any pair does not match, then in step 744 the integrity engine determines that a Web inject attack has taken place and generates an alert, logs the discrepancy, redirects the session to another server, the session may be terminated, a customer-defined action may be taken, or takes other action such as locking the user's account. If all fingerprint pairs do match, then in step 740 no action need be taken. Note that the fingerprint values calculated by the SSC may optionally be cached, as it may be assumed that, depending upon the architecture of the protected Web application, once a fingerprint is calculated for given form on a given page, that fingerprint may be the same the next time that page is rendered.

It is also possible that malware executing on the user's computer is preventing the fingerprint calculation of steps 728 and 732. In that case, no fingerprint will be received at the integrity engine from the user computer. Therefore, step 736 may also determine that no fingerprint has been received and that malware is executing on the user computer. Therefore, an action may be taken such as generating an alert, logging the discrepancy, redirecting the session to another server or Web site, blocking or terminating the session at the protector server to prevent access to the Web application, taking a customer-defined action, locking the user's account, etc.

Note that in the example of FIG. 11B, the malware is still successful in sending information taken from the fake form to its C&C software 61. While the protection code of this third embodiment is not able to completely disable the malware from executing, it is able to detect its execution and take appropriate action. And, it should be noted that similar to the above embodiments, this third embodiment will operate whether or not malware is actually executing upon the user computer, and does not need to detect any malware on the user computer in order to perform its protective actions. In addition to executing the protection code of this third embodiment, the protection code of the second embodiment (FIGS. 9-10) may also be inserted into the returned Web page so that any input form data sent by the browser from the user computer (including any data input into a fake field created by the malware) will be encrypted. Shown is encrypted form data 256 and 264. In this situation, protector server 100 will decrypt this form data as discussed in the second embodiment before sending the input form data to the Web application 60.

### Protection Against Phishing

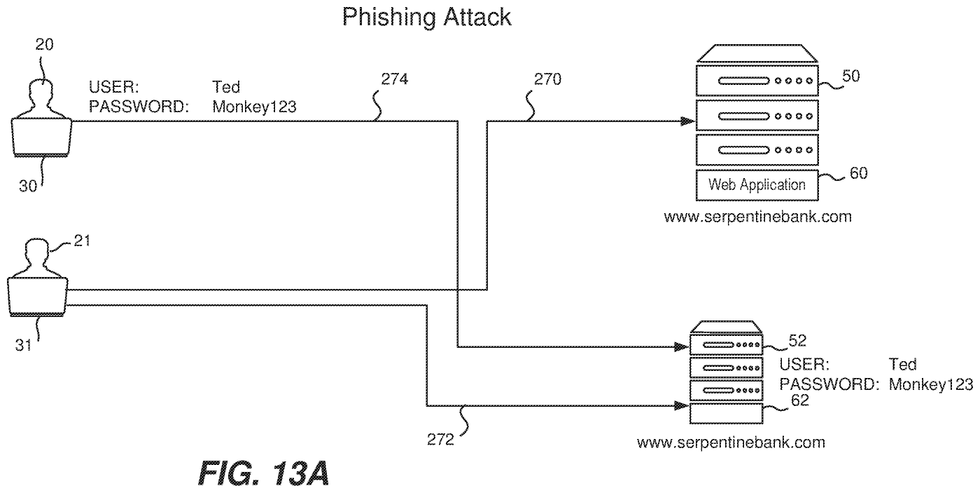

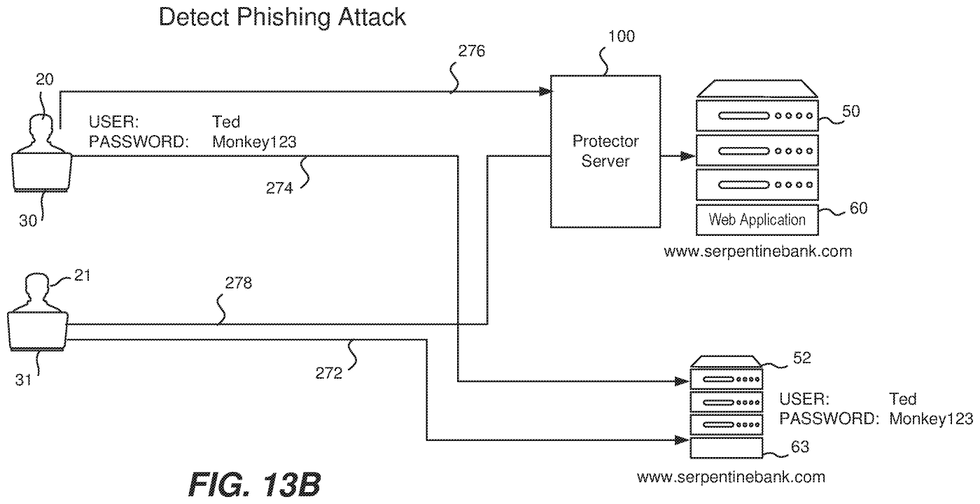

FIGS. 13A and 13B illustrate a fourth embodiment in which the invention detects a phishing attack in progress against the user computer. FIG. 13A illustrates how a malicious user 21 may use malicious phishing software to actively dupe a computer user 20. Shown is how a malicious user 21 may access the Web application 60 over Internet link 270 in order to copy all or parts of the Web application 60. Malicious user 21 then sets up a bogus Web application 62 on computer server 52 over Internet link 272 using the copy. In this example, the bogus domain name is “www.5erpentinebank.com” and not “www.serpentinebank.com.” Typically, a malicious user makes a copy of a login Web page and hosts it on a different domain in order to steal user credentials, although an entire Web site may be copied as well.

Malicious user 21 then tricks user 20 into accessing the bogus Web application 62 from user computer 30; this can be done through a false e-mail message or other means, which convinces user 20 into clicking on a link for application 62, when the user actually thinks he or she is accessing application 60. Phishing techniques may also cause changes in a DNS such that the user computer is fooled into thinking it is actually requesting a Web page from “www.serpentinebank.com.” When user computer 30 interacts with the bogus Web application 62 over Internet link 274, user 20 may then provide a user name and password, payment data, or other sensitive information, which will then be in the control of malicious user 21.

FIG. 13B illustrates how this embodiment of the invention detects that such a phishing attack is in progress and users are actively being duped. As explained earlier, protector server 100 is now present in the Web traffic path 276 between computer 30 and server computer 50, and similarly is also present in the Web traffic path 278 between computer 31 and server computer 50. Typically, during a valid session between user 20 and computer 50 over Internet link 276, server 100 will send a session cookie to the browser of computer 30. Also, server 100 will keep track of an active session with computer 30 by collecting information such as user name of the user, IP address, browser type, and other “fingerprint” data of a computer such as: browser version, operating system type and version, screen size, time zone, browser settings (like preferred language, available fonts, etc.) In this way, server 100 can keep track of with which computers it is having an existing, valid session.

When the malicious user 21 uses computer 31 to interact with Web application 60 over Internet link 278 in order to copy all or parts of the Web application 60, he or she will necessarily copy the protection code which the protector server 100 injects into the returned Web page or pages. This protection code is then included (along with the rest of the copy) in the bogus Web application 63 created by the malicious user 21.

As above, malicious user 21 then tricks user 20 into accessing the bogus Web application 63 from user computer 30, via a false e-mail message or other means. When user computer 30 interacts with the bogus Web application 63 over Internet link 274, a Web page will be downloaded to computer 30 along with the protection code, the protection code executes, and sends a notification with contextual information back to protector server 100 on Internet link 276.

When protector server 100 receives such a notification, it checks to make sure a valid session exists for the request by checking a session token, the fingerprint of the computer, or other information. If a valid session does not exist, then protector server 100 raises an alert that a phishing attack is in progress. Furthermore, server 100 may use the contextual information included in the notification to identify that user 20 has been a victim of the attack.

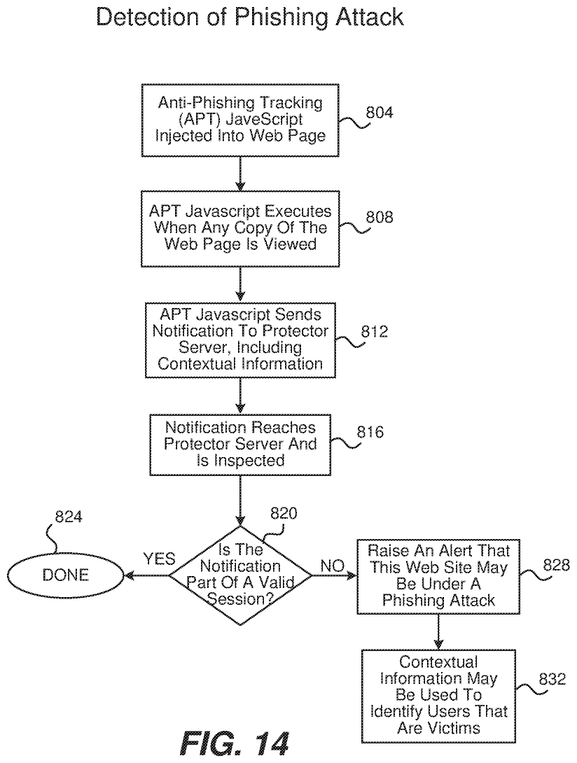

FIG. 14 is a flow diagram describing how the protection code detects a phishing attack. Malicious user 21 desires to initiate a phishing attack and contacts Web application 60 in order to copy one or more of its Web pages. Accordingly, an HTTP request is sent over link 278 from the browser of computer 31 to Web application 60 and is directed to protector server 100 as has been described above. Next, protector server 100 requests the desired Web page or pages from origin server 50. Next, in step 804 when the page or pages are returned to malicious computer 31, protector server 100 inserts protection code (referred to as anti-phishing tracking, APT, code) into one or all of the Web pages as has been explained above in FIG. 4. This protection code will then execute in the browser of the user computer as explained below. When malicious user 21 then creates a bogus Web application 63 that includes these copied Web pages, this bogus application 63 will necessarily include the APT code.

Next, when the unsuspecting user 20 is duped by the phishing scam and clicks upon a link causing his or her computer to access malicious server computer 52 (instead of using a link 276) and bogus Web application 63 over Internet link 274, his or her computer will download a Web page from bogus application 63 that will include the APT code. In step 808, when the user views this downloaded Web page, his or her browser will execute this APT code. When executed, in step 812, this APT code sends a notification over Internet link 276 to protector server 100 that includes contextual information from this session. This notification and information may be sent periodically or upon certain events, such as every time a user views a new page on the Web application, clicks on a link, fills out and submits a form, etc. This contextual information may include any session cookie previously sent to the user computer from protector server 100, user computer fingerprint data listed above, etc. In general, there are four categories of information that may be included in the contextual information: the session cookie previously sent (if available); computer fingerprint data; any relevant form data if the user is filling out a form, such as user name and e-mail address (which data will be useful in identifying which user fell victim to the attack, when sent in an alert); and, a unique identifier for each Web site that is part of the APT.

The APT code may also send the name of the domain from which it originated (i.e., the Web site on which it is hosted) as part of the contextual information. The APT code uses a mechanism in JavaScript executing in a browser to find out from which domain the current Web page was served (the specific code is “document.location”), and is able to send the name of this domain back to server 100. In this example, Web application 63 is hosted by “www.5erpentinebank.com,” and this domain is sent back.

In step 816 this notification reaches protector server 100 and the server inspects this contextual information to determine if a valid session exists. In order to determine if a valid session exists, in step 820 server 100 may use a variety of techniques. In one technique, server 100 determines if the session cookie it might have previously sent to computer 30 is present in the contextual information. If not, this indicates that computer 30 never initiated a session over link 276 to legitimate application 60 via server 100. In this case, server 100 concludes that a valid session does not exist and that phishing is likely.

In another technique, server 100 checks the identifying information of the user computer in the contextual information (such as IP address, browser type, etc.) and determines if this identifying information matches any other session information it has stored previously during sessions with other user computers (i.e., does the computer fingerprint data match any active sessions, within a certain tolerance in case some data has changed, e.g., a browser setting may have changed). By way of example, if contextual information includes “IP address is: 10.0.0.124” and “browser type is: Firefox,” yet, server 100 has no record of any session with a user computer having this information, this is a good indication that the current session is not valid and that phishing is likely.

In a third technique, server 100 uses the name of the domain in which the APT code is being hosted to determine if a phishing attack may be occurring. Using the example above, when server 100 receives the domain “www.5erpentinebank.com” as being the name of the domain in which the Web page is hosted, server 100 can determine if this domain is likely a phishing domain. This determination can be made in different ways. In one way, each Web application that is protected by server 100 will have a unique identifier that is part of the APT for that particular Web application (if multiple Web applications are protected then each has a unique identifier). Thus, the copy of the Web application that is used to create the bogus Web application will also include that unique identifier in the APT that is injected. Therefore, when server 100 receives the domain “www.5erpentinebank.com” and the unique identifier of the legitimate domain, it checks to see if the protected Web application identified by the unique identifier matches the domain provided in the contextual information. If not, the session is not valid and phishing is likely. The received domain may also be compared to the actual name of the legitimate Web site. In a second way, the received domain “www.5erpentinebank.com” is compared to a blacklist or other database of known phishing Web sites; if on the list, the session is not valid and phishing is likely.

If a valid session does exist, then in step 824 the analysis ends as it appears that a phishing attack is not underway. On the other hand, if a valid session does not exist, then in step 828 protector server 100 raises an alert that a phishing attack is in progress by notifying Web application 60 or other entity of the enterprise. Server 100 may also take other actions such as: logging the attack; taking a customer-defined action; sending an alert to user 20, to his or her computer 30, to server 100, to the enterprise that hosts the legitimate Web application, to the legitimate Web application itself, etc.; locking the user's account; sending an alert to the phishing Web site's ISP or domain registrar so that it may be shut down; etc.

Furthermore, in step 832 server 100 may use the contextual information included in the notification to identify in the alert that user 20 and its computer 30 have been a victim of the attack.

### Web Application Firewall

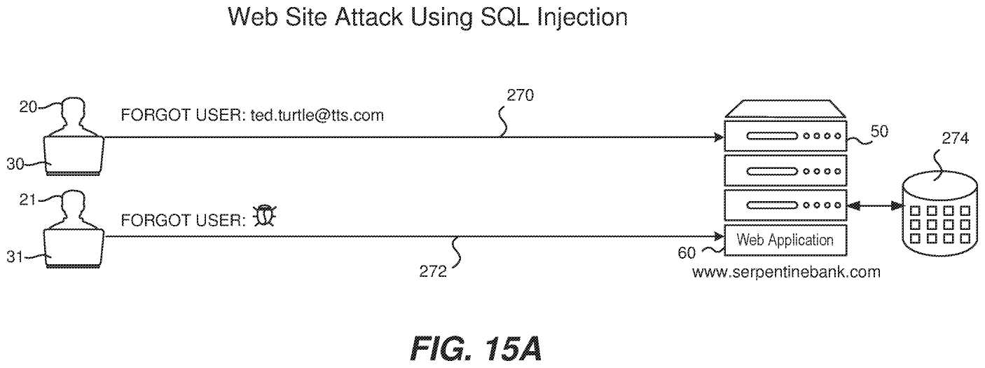

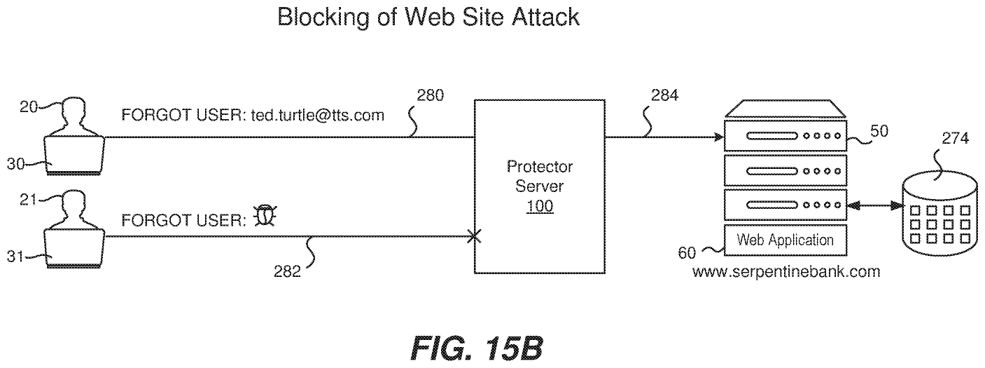

FIGS. 15A and 15B illustrate a fifth embodiment in which the invention provides a Web application firewall (WAF). FIG. 15A illustrates how a malicious user 21 may use malicious software in order to harm a Web site using SQL injection before use of the present invention. As explained above, this malicious software may have been installed upon the user computer using any of a variety of techniques, and maybe executing within the operating system of the computer or within the browser.

When the user 20 interacts with Web application 60 over Internet link 270 in order to recover a forgotten user name (for example), the Web application includes a form that is downloaded as part of a Web page to the user computer 30. The user is supposed to enter his or her e-mail address (for example) in a field of the form so that the Web application in conjunction with database 274 may send back the user's user name. The malware executing upon the user computer, however, injects special characters into that field that will cause database 274 to be manipulated, to possibly change data, to send sensitive data to the malicious user, etc. The user sending the requests may be the malicious party, or unwittingly provides cover for the malware (executing upon the user computer) that is attempting to compromise the Web application.

FIG. 15B illustrate how WAF code within protector server 100 is able to block this Web site attack. Because all responses 280 from the user computer pass through protector server 100 before being passed along 284 to the Web application, the WAF code is able to screen any desired field of a form in order to let pass through reasonable looking responses, but also to remove or block any malicious string of characters found within a field before the response is returned to the Web application. The malicious user is effectively blocked 282 from harming the Web application or its component. Accordingly, the WAF code is able to block attempts to exploit vulnerabilities in a Web application or in its components. Advantageously, this embodiment of a WAF may be used in conjunction with any of the other embodiments described above, i.e., whether or not protector server 100 inserts any or all of the protection code of the above embodiments, the WAF code may be present within server 100 and will provide protection for the Web application.

### Specific Implementation

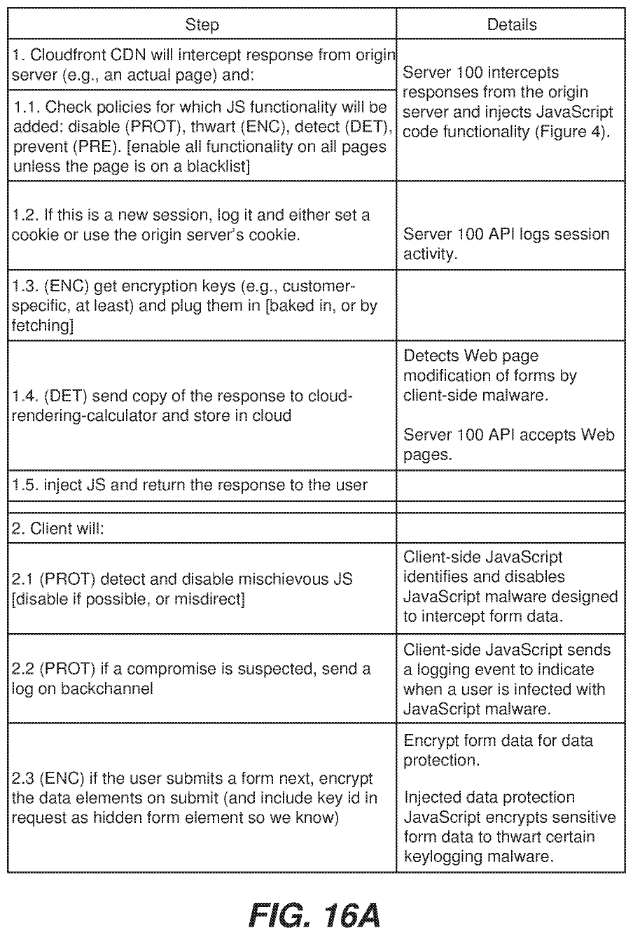

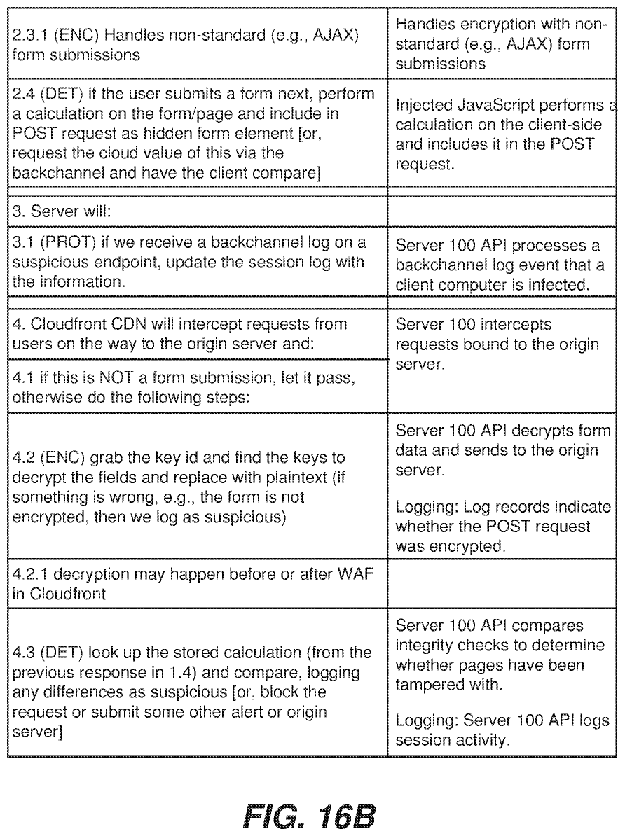

FIGS. 16A and 16B are a flow diagram that describes one specific manner of embodiment of the invention in which the Cloudfront CDN is used to host protector server 100. This flow describes a request-response flow between an origin server 50, intermediate computer server 100 and a user host computer 30. Of course, embodiments of the invention may be implemented in other manners such as hosting protector server 100 on Amazon Web services, on hardware of the enterprise, on another cloud service provider, or upon any suitable Internet-accessible infrastructure.

### Correlation of Endpoint Computers

In addition to detecting, thwarting or blocking malware on a user computer, that same user computer may be tracked across different users once malware is detected. For instance, if endpoint malware is detected on a user computer when a user logs into a bank account, that user and session are flagged and reported to the bank (i.e., the Web application of the bank) in case the bank may wish to apply additional review on any transactions from that user or from that computer. In addition, the same user computer may be tracked across different users once malware is detected. Thus, if endpoint malware is detected on a user computer when a user logs into a bank account, additional users who subsequently use the same computer are also flagged so that any restrictions can be enforced or additional fraud reviews can be performed on the users' activity. This flagging is done by fingerprinting the user computer, and then flagging that fingerprint in the invention's server infrastructure, such as in protector server 100. Thus, one enterprise may track different users of the same computer, or different enterprises may track the same computer, which might have different users.

Further, if a service provider is providing the invention to multiple enterprises the service provider can track the same endpoint across the multiple enterprises. This is useful depending upon the malware. For instance, some malware works by modifying, e.g., “bankofamerica.com” with a Web inject, but not other Web sites. If the service provider is protecting both “bankofamerica.com” and “ebay.com,” and detects malware when the endpoint visits “bankofamerica.com” the service provider (i.e., server 100) can then block that endpoint from also accessing “ebay.com” even if no malware is detected when the endpoint is visiting “ebay.com.”

The cross-enterprise is yet another scenario. Any alerts from compromised user computers from one Web site can be used to provide threat intelligence that would benefit other Web sites, both for the same enterprise and others. Malware on a user computer that affects one Web site may also affect other Web sites, so users and sessions that use a user computer that is known to have malware can automatically be flagged when accessing other Web sites.

### Additional Embodiments

The invention includes these additional embodiments.

A6. A method as recited in claim 1 wherein said protection code is further arranged to not determine whether said malware does exist on said user computer.

A7. A method as recited in claim 1 wherein no additional software is necessary on said user computer in order to disable said malware.

A8. A method as recited in claim 1 wherein no additional software is necessary on said origin Web server in order to disable said malware.

B3. A method as recited in claim 9, wherein said request identifies a domain of said origin Web server, and wherein said request is received at said protector server by virtue of a DNS entry that directs said request to said protector server.

B4. A method as recited in claim 8 wherein said protection code is further arranged to establish itself as the lowest entry in an event handler stack of said Web page.

B11. A method as recited in claim 8 wherein said protection code is inserted into said Web page such that said protection code executes before other code in said Web page executes in said browser.

B12. A method as recited in claim 8 wherein said Web page includes said reference, said method further comprising:

retrieving said protection code using said reference before executing said protection code in said browser.

C3. A method as recited in claim 17, wherein said request identifies a domain of said origin Web server, and wherein said request is received at said protector server by virtue of a DNS entry that directs said request to said protector server.

C6. A method as recited in claim 16 wherein said protection code is further arranged to not determine whether any malware does exist on said user computer.

C7. A method as recited in claim 16 wherein no additional software is necessary on said user computer in order to detect said malware.

C8. A method as recited in claim 16 wherein no additional software is necessary on said origin Web server in order to detect said malware.

D2. A method as recited in claim 26, wherein said request identifies said domain of said origin Web server, and wherein said request is received at said protector server by virtue of a DNS entry that directs said request to said protector server.

D3. A method as recited in claim 25 wherein said protection code is inserted into said Web page such that said protection code executes before other code in said Web page executes in a browser.

D4. A method as recited in claim 25 wherein said Web page includes said reference, said method further comprising: retrieving said protection code using said reference before executing said protection code in said browser of said second computer.

D9. A method as recited in claim 25 wherein no additional software is necessary on said second computer in order to detect said phishing.

D10. A method as recited in claim 25 wherein no additional software is necessary on said origin Web server in order to detect said phishing.

D11. A method as recited in claim 25, further comprising: receiving, at said protector server, a request from said first computer for said Web page; and forwarding said request to said Web site.

### Computer System

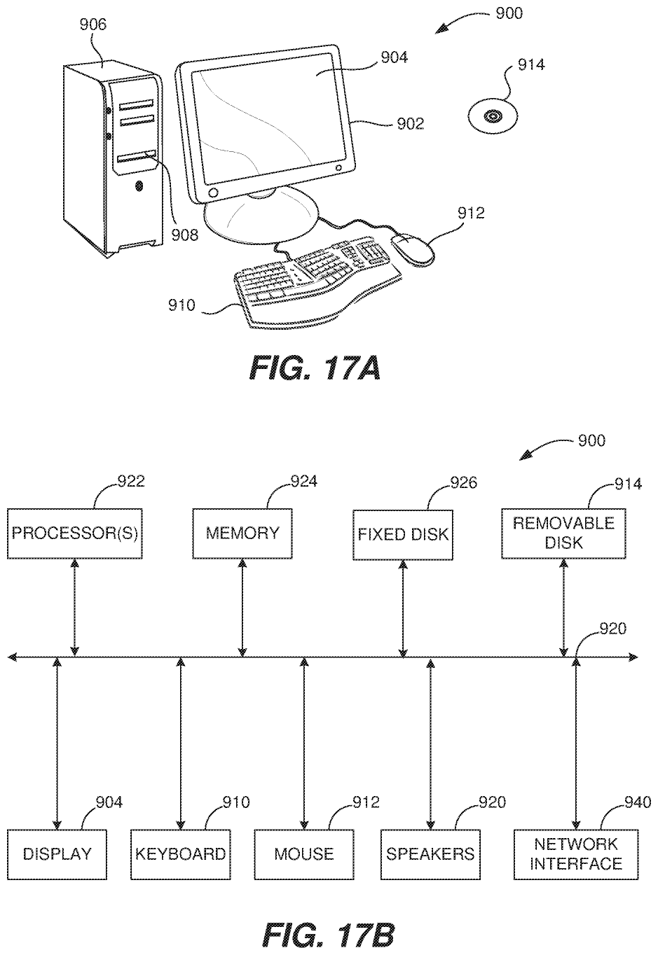

FIGS. 17A and 17B illustrate a computer system 900 suitable for implementing embodiments of the present invention. FIG. 17A shows one possible physical form of the computer system. Of course, the computer system may have many physical forms including an integrated circuit, a printed circuit board, a small handheld device (such as a mobile telephone or PDA), a personal computer or a super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 17B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary mass storage medium (such as a hard disk, a solid-state drive, a hybrid drive, flash memory, etc.) that can be slower than primary storage but persists data. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. A method of thwarting malware on a user computer, said method comprising:
receiving, at a protector server, a Web page from an origin Web server in response to a request from a user computer;
inserting protection code or a reference to said protection code into said Web page to produce a modified Web page; and
returning said modified Web page to said user computer, wherein said protection code is arranged to
execute in a browser of said user computer, and
encrypt data of a form of said Web page, said data being input by a user or application of said user computer, before said form and said data are submitted by said browser to an operating system of said user computer.

2. A method as recited in claim 1, further comprising:
receiving, at said protector server, a request from said user computer for said Web page; and
forwarding said request to said origin Web server.

3. A method as recited in claim 2, wherein said request identifies a domain of said origin Web server, and wherein said request is received at said protector server by virtue of a DNS entry that directs said request to said protector server.

4. A method as recited in claim 1 wherein said protection code is further arranged to establish itself as the lowest entry in an event handler stack of said Web page.

5. A method as recited in claim 1 wherein said protection code is further arranged to
encrypt said data of said form after a submit form event of said form is handled by said event handler stack.

6. A method as recited in claim 1 wherein said protection code is further arranged to
not determine whether any malware does exist on said user computer.

7. A method as recited in claim 1 wherein no additional software is necessary on said user computer in order to disable said malware.

8. A method as recited in claim 1 wherein no additional software is necessary on said origin Web server in order to thwart said malware.

9. A method as recited in claim 1 further comprising:
receiving, at said protector server, said form with said encrypted data submitted by said user;
decrypting said data of said form; and
submitting said form and said decrypted data to said origin Web server.

10. A method as recited in claim 1 further comprising:
receiving, at said protector server, said form and said data input by said user, said data not being encrypted; and
taking an action when it is determined that said data is not encrypted.

11. A method as recited in claim 1 wherein said protection code is inserted into said Web page such that said protection code executes before other code in said Web page executes in said browser.

12. A method as recited in claim 1 wherein said Web page includes said reference, said method further comprising:
retrieving said protection code using said reference before executing said protection code in said browser.

13. A method as recited in claim 1 wherein said protection code executes when said browser begins executing code in said modified Web page and before any other code in said modified Web page executes in said browser.
